(19) United States
(12) Patent Application Publication
(10) Pub. No.: US 2011/0204617 A1
(43) Pub. Date: Aug. 25, 2011

(54) SECURITY ARTICLE AND METHOD OF MANUFACTURE

(75) Inventors: Matthew Charles Sugden, Basingstoke (GB); Robert William Harrison, Woking (GB)

(73) Assignee: DE LA RUE INTERNATIONAL LIMITED, Basingstoke, Hampshire (GB)

(21) Appl. No.: 13/120,316

(22) PCT Filed: May 8, 2009
(86) PCT No.: PCT/GB2009/001142

§ 371 Date: May 6, 2011

(30) Foreign Application Priority Data
Oct. 6, 2008 (GB) 0818270.1

(51) Int. Cl. B42D 15/00; B32B 38/14

(52) U.S. Cl. 283/85; 156/277; 156/272.8

(57) ABSTRACT

A method of manufacturing a security article (10) is provided, comprising applying an first adhesive layer to a substrate (11), the first adhesive layer comprising an additive which is responsive to at least a selected wavelength of laser radiation (12); and applying a laminate over the first adhesive layer, the laminate comprising a second adhesive layer which adheres to the first adhesive layer. Prior to applying the laminate over the first adhesive layer, data is printed onto the first and/or second adhesive layer, such that on applying the laminate over the first adhesive layer, the printed data is incorporated between the first and second adhesive layers. Also provided is a security article comprising a substrate having upper and lower surfaces; a first adhesive layer applied to the upper surface of the substrate, the first adhesive layer comprising an additive which is responsive to at least a selected wavelength of laser radiation; a print layer; and a laminate comprising a second adhesive layer bonded to the first adhesive layer. The print layer is incorporated between the first and second adhesive layers.

This invention relates to security articles including documents and security elements, particularly security documents such as identification cards, passports, driving licences, credit cards, currency etc., as well as security elements which may be applied to such documents, and methods for manufacturing such security articles.

Conventional identification cards and similar documents typically incorporate information printed onto a core material or substrate such as Teslin™ (available from PPG Industries) which is then laminated between cover layers of a plastics material such as polyester. Teslin™ is a mixture of polypropylene and polyethylene with silica. Typical Teslin™ grades are up to 70% air by volume and so are light, flexible and have high porosity which makes them particularly suitable for use as a substrate for printing and laminating.

To improve the security of such documents, it is desirable to be able to laser mark the card. This differs from conventional printing in that, rather than an ink being laid down, the card material itself is modified by a laser beam in a visually noticeable manner. This enables data such as text, images or codes to be inscribed into the card in a way which is very difficult to reverse or change.

However, Teslin™ is not itself suitable for laser marking since it is near transparent to typical laser radiation wavelengths, for example 10.6 μm, 532 nm and 1064 nm. Instead, where a laser-markable document is required, a polycarbonate core is typically used inside a laminated structure. Certain types of polycarbonate can be marked with a laser and hence data can be inscribed into the polycarbonate.

Nonetheless, polycarbonate cards do not possess the advantageous qualities of Teslin™ and it would therefore be desirable to have a technique which does not depend on the use of laser-markable core materials such as polycarbonate. Laminates including a laser-markable substance have been proposed to replace the conventional polyester cover layers, as disclosed in EP-A-0987121, U.S. Pat. No. 6,179,338 and US-A-2004/0198858, for example, but since laser-markable materials are typically non-transparent, and indeed often opaque, this has an impact on the appearance of the graphics and information printed on the core substrate. To avoid obscuring the printed data entirely, it has been necessary either to provide the laser-markable substance in very dilute quantities, limiting the effect of the laser marking process, or arrange the laser-markable layer so as not to overlap the printed data.

According to the present invention, a method of manufacturing a security article comprises:
applying an first adhesive layer to a substrate, the first adhesive layer comprising an additive which is responsive to at least a selected wavelength of laser radiation; and
applying a laminate over the first adhesive layer, the laminate comprising a second adhesive layer which adheres to the first adhesive layer;
wherein, prior to applying the laminate over the first adhesive layer, data is printed onto the first and/or second adhesive layer, such that on applying the laminate over the first adhesive layer, the printed data is incorporated between the first and second adhesive layers.

The manufactured security article may be, for example, a document or a security element for application to, or incorporation into, a document or other product.

By arranging the printed data to overlay the laser-markable first adhesive layer, no diminishing of the appearance of the print is caused by the laser-markable additive. Thus, any suitable material (or even a composite core) may be selected for use as the substrate, for example Teslin™, whilst the article can support both printed data and laser inscription to equal visual effect. By incorporating the printed data layer directly between two adhesive layers, the article is highly tamper-evident. Any attempt to delaminate the article by separating the first and second adhesive layers will lead to the printed data being greatly distorted or, likely, destroyed.

“Adhesives” will be well known to the skilled reader as a term in common usage and it will be appreciated that its usual sense is applied here. For instance, an “adhesive” is a material which is tacky, or can be made to become tacky (e.g. by heating), so as to adhere to a surface or bond two surfaces together. Suitable adhesives include contact adhesives and heat-activated adhesives. Preferably, the bond between the first and second adhesive layers is stronger than that between the first adhesive layer and the substrate.

In many cases, the security article produced according to the above method is considered finished and the end user may later, if desired, make use of the laser-markable layer by inscribing data. However, in other preferred embodiments, such data may be inscribed at source, in which case the method preferably further comprises:
irradiating a selected region of the security article with laser radiation of at least the selected wavelength, thereby inscribing data into the first adhesive layer.

The additive incorporated in the first adhesive layer could respond to laser irradiation in any manner which results in a noticeable change to the adhesive material or the additive itself. However, preferably, the additive incorporated in the first adhesive layer is absorbent to radiation of at least the selected wavelength.

Preferably, the first adhesive layer undergoes an optically recognisable change upon exposure to radiation of at least the selected wavelength. For example, absorption of the radiation by the additive can lead to a local heating effect causing modification either of the surrounding adhesive material in the layer or to a coating which surrounds the laser sensitive additive, which is visible to an observer. However, preferably the first adhesive layer is blackened upon exposure to radiation of at least the selected wavelength. This can result for example from charring caused by the heating effect.

The first adhesive layer may alternatively or additionally undergo a physically recognisable change upon exposure to radiation of at least the selected wavelength. That is, the laser inscribed data may be detectable by touch as well as, or instead of, sight. This can be achieved by appropriate selection of the laser marking conditions and provides a further improvement to the security of the article since such tactile markings cannot be replicated by scanning or photocopying. Tactility is defined as having areas of the article which are raised relative to other areas of the article surface.

Any suitable additive may be selected, transparent, translucent or otherwise. However, in preferred embodiments, at least part of the first adhesive layer is substantially opaque in the visible spectrum. This may be as a result of the properties of the adhesive material itself, the laser-markable additive or another additive. By doing so, the appearance of the substrate itself need not be tightly controlled and there is no constraint on the colour of the substrate.

Advantageously, the first adhesive layer is applied to the substrate in at least partially molten form, preferably by extrusion. Especially where the substrate comprises a porous material, such as Teslin™ or even paper, such application techniques result in a particularly strong bond between the substrate and the adhesive layer, since the adhesive material permeates a distance into the substrate microstructure before setting.

Preferably, data is printed onto the first or second adhesive layer by offset, lithographic, inkjet or laser printing. Visible inks and/or security inks (such as UV or IR responsive inks, for example) can be used as desired.

In a particularly preferred embodiment, the first and second adhesive layers comprise the same adhesive material, such that upon bonding to one another, a single continuous adhesive layer is formed, with the printed data incorporated therein. It should be noted however that the second adhesive layer typically does not comprise any laser-markable additive, so as to avoid impairing the appearance of the printed data. However, the second adhesive layer could also comprise such an additive if a suitable, near visually transparent substance were available. This additive would not need to be the same as that incorporated within the first adhesive layer.

Advantageously, the first and/or second adhesive layers comprise a heat sealing adhesive, preferably polyethylene/ethylene vinyl acetate (PE/EVA), acrylic or polyurethane systems. However, in other embodiments, alternative adhesive types such as curable resins could be used.

Preferably, the laminate further comprises a protective cover layer of substantially transparent material. This shields the adhesive layers, and printed data within, from damage which could otherwise occur during handling. However, the cover layer could be omitted if the second adhesive layer is itself settable to provide a suitable outer coating. Where used, the cover layer preferably comprises a plastics material, such as PET, PVC, polycarbonate, PBT or any combination (e.g. blends) of these.

In a particularly preferred embodiment, the laminate is applied by roll lamination. However the particular application technique selected will depend on the nature of the first and second adhesive layers. For example, in other implementations, hot pressing may be suitable.

Advantageously, the additive comprises a pigment, preferably antimony oxide or Micabs™, which is a range of additives supplied by Royal DSM N.V.

Preferably the selected wavelength of radiation is in the range 240 nm to 11000 nm. Particularly preferred wavelengths are around 532 nm, generated by a DPSS (diode pulsed solid state) laser, 1064 nm, generated by a Nd:YAG laser and 10600 nm, generated by a CO₂ laser.

In many cases, the substrate itself may be left unprinted. However, in certain preferred embodiments, the substrate is printed prior to application of the first adhesive layer. Printing may be applied to one or both sides of the substrate but typically only the side of the substrate to which the first adhesive layer is not to be applied would be printed.

The side of the substrate to which the first adhesive layer is not applied can be treated in a number of ways. Preferably, where the substrate has upper and lower surfaces, the first adhesive layer being applied to the upper surface, the method further comprises applying a second laminate to the lower surface of the substrate. This protects the lower surface of the substrate, and any printed data thereon, from damage during handling. In other examples the lower surface could be left uncovered: for instance, where the article is an element to be adhered to a document, the substrate surface can be left available for bonding to the document using a suitable adhesive.

In preferred embodiments, the second laminate may be applied directly to the substrate, in a conventional manner using an adhesive, preferably a heat sealing adhesive. In other preferred embodiments, the second laminate comprises a fourth adhesive layer, and, prior to applying the second laminate:
a third adhesive layer is applied to the lower surface of the substrate, the third adhesive layer comprising an additive which is responsive to at least a selected wavelength of laser radiation; and
data is printed onto the third and/or fourth adhesive layer, such that on applying the second laminate over the third adhesive layer, the printed data is incorporated between the third and fourth adhesive layers.

Thus, both sides of the article can be provided with both printed data and laser inscription.

Preferably, the second laminate comprises a protective cover layer. However, in this case the cover layer need not be transparent if, for example, there is no desire to be able to view the substrate, or any printed data, therethrough.

The above steps could be carried out for each individual article. However, preferably, the method further comprises, after applying the laminate(s), cutting the assembled substrate and laminate combination into individual articles. Preferably such a cutting step would be carried out before laser inscription.

The invention further provides an article comprising:
a substrate having upper and lower surfaces;
a first adhesive layer applied to the upper surface of the substrate, the first adhesive layer comprising an additive which is responsive to at least a selected wavelength of laser radiation;
a print layer; and
a laminate comprising a second adhesive layer bonded to the first adhesive layer, the print layer being incorporated between the first and second adhesive layers.

Such an article possesses the advantages described above, namely being capable of displaying both printed and laser inscribed data to equal visual effect, and being tamper evident as a result of the printed data being encapsulated in an effectively frangible layer.

Advantageously, the substrate comprises a porous material, preferably a silica filled polyolefin such as Teslin™. Any desired substrate could be used, but porous materials such as Teslin™ are capable of forming a very strong bond with the applied adhesive layer. For toughness and resilience, the substrate is preferably of a plastics material although cellular or fibrous materials such as paper could also be used.

Preferably, the first and second adhesive layers comprise the same adhesive material such that, when bonded together, the first and second adhesive layers form a single continuous adhesive layer, the print layer being incorporated therewithin. The use of the same material in each layer is preferred since this typically results in a very strong bond between the two layers. However, dissimilar adhesive materials may be used provided they are compatible with one another.

Preferably, the laminate further comprises a protective cover layer of transparent material.

Advantageously, the article is a security document, preferably an ID card, passport, or driving licence, or a credit or debit card, or currency. In other preferred embodiments, the article is a security element, such as an insert, label, transfer, thread or patch.

The security element could ultimately be arranged either wholly on the surface of a document, as in the case of a stripe or patch, or may be visible only partly on the surface of the document in the form of a windowed security thread.

Security threads are now present in many of the world's currencies as well as vouchers, passports, travellers' cheques and other documents. In many cases the thread is provided in a partially embedded or windowed fashion where the thread appears to weave in and out of the paper. One method for producing paper with so-called windowed threads can be found in EP0059056. EP0860298 and WO03095188 describe different approaches for the embedding of wider partially exposed threads into a paper substrate, any of which are suitable for incorporating the security article into a document. Wide threads, typically with a width of 2 to 6 mm, are particularly useful as the additional exposed area allows for better use of overt security features such as those provided by the present invention.

The security element could be incorporated into a document such that regions of the element are viewable from both sides of the document. Techniques are known in the art for forming transparent regions in both paper and polymer substrates. For example, WO 8300659 describes a polymer banknote formed from a transparent substrate comprising an opacifying coating on both sides of the substrate. The opacifying coating is omitted in localised regions on both sides of the substrate to form a transparent region.

Methods for incorporating a security device such that it is viewable from both sides of a paper document are described in EP1141480 and WO03054297. In the method described in EP1141480, one side of the device is wholly exposed at one surface of the document in which it is partially embedded, and partially exposed in windows at the other surface of the substrate.

In the case of a stripe or patch, the security element is preferably prefabricated on a carrier substrate and transferred to the substrate in a subsequent working step.

Examples of articles and methods of manufacture thereof will now be described with reference to the accompanying drawings, in which:—

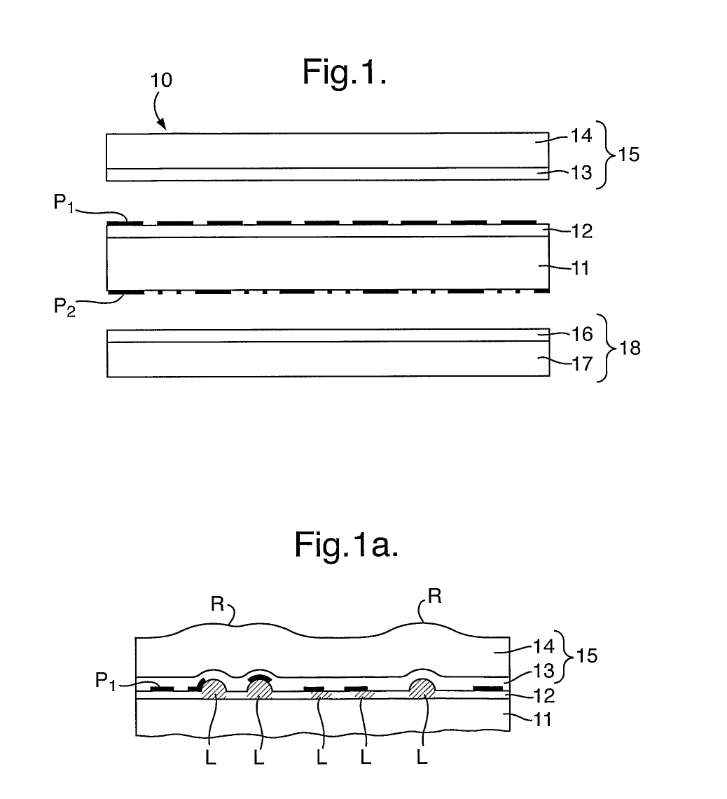

FIG. 1 is an exploded schematic cross section through an article according to a first embodiment of the invention;

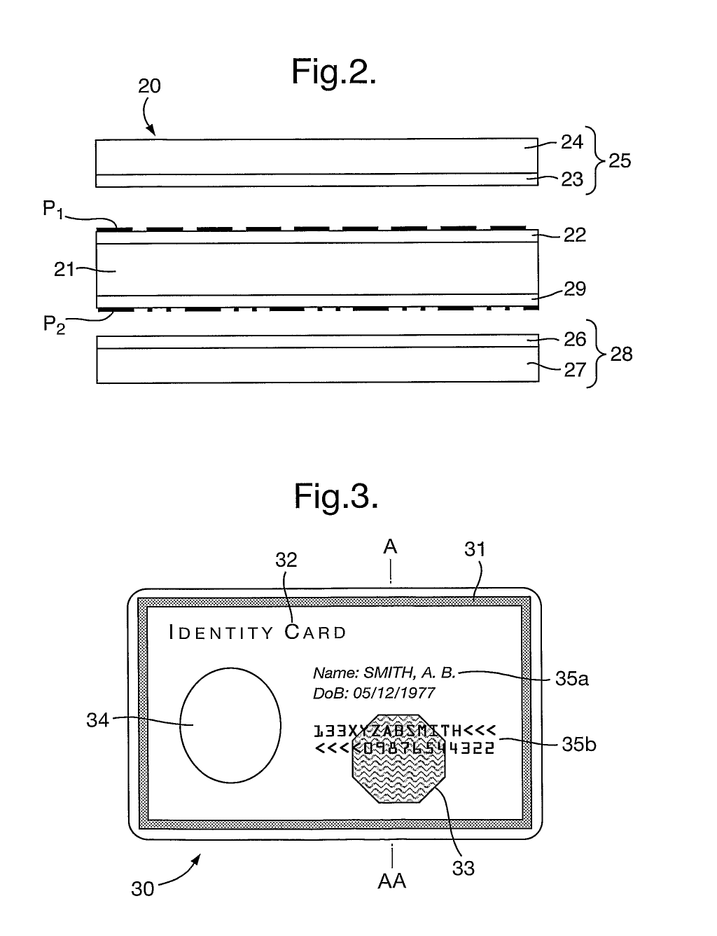

FIG. 2 is an exploded schematic cross section through an article according to a second embodiment of the invention;

FIG. 3 shows an article according to a third embodiment of the invention;

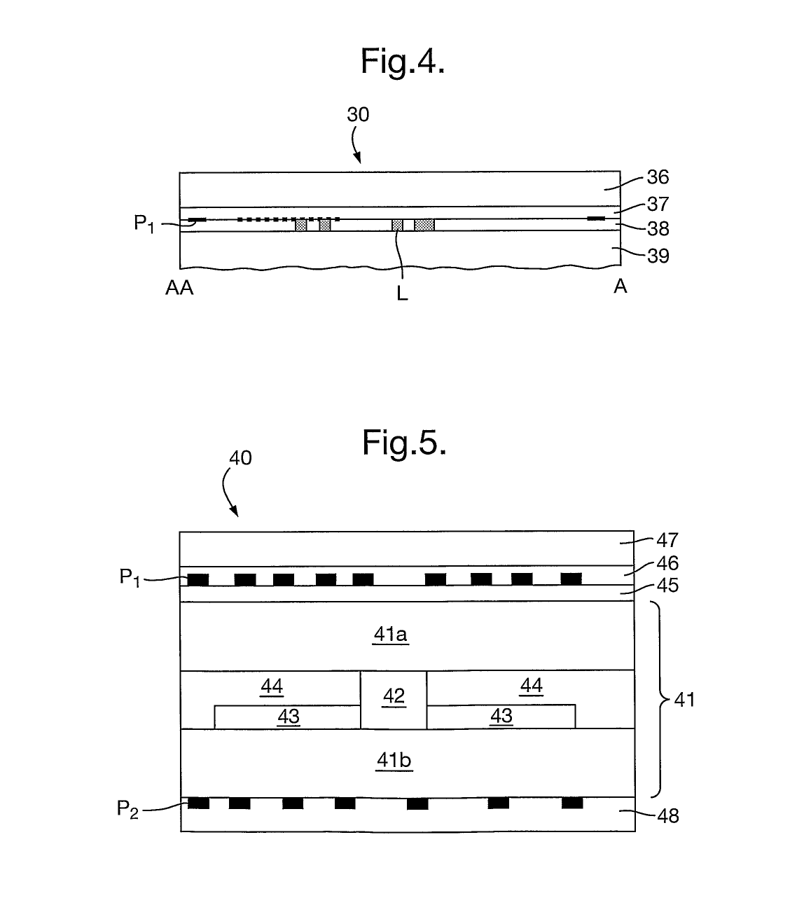

FIG. 4 is a partial cross section through the article of FIG. 3 along the line A-AA.

FIG. 5 shows a schematic cross section through an article according to a fourth embodiment of the invention; and

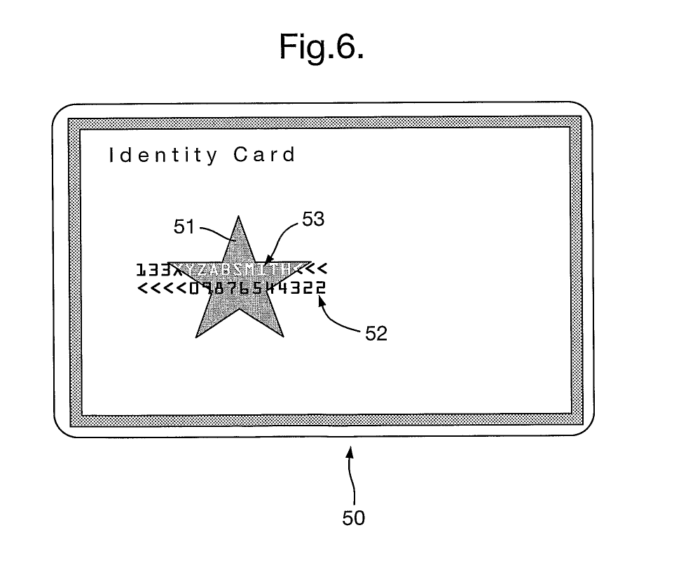

FIG. 6 shows an article according to a fifth embodiment of the invention.

FIG. 1 shows a first embodiment of the invention in exploded cross section, various layers of the article 10 being spaced apart for clarity. It should be noted that in this drawing, as in the other Figures, the thicknesses of the layers are exaggerated and not necessarily to scale with one another.

A substrate 11 formed of a suitably robust material such as Teslin™ is used as the core of the article 10. The substrate itself may be printed or unprinted. In this example, the upper surface of the substrate 11 is unprinted, whereas the lower surface is printed with a print layer P₂.

A laser-markable adhesive layer 12 is coated onto the upper side of the substrate. In this example, the adhesive is a heat sealable adhesive such as PE/EVA (Polyethylene/Ethylene Vinyl acetate) with a laser markable additive incorporated therein. Heat sealable adhesives are particularly advantageous as they may be extruded onto the substrate 11 (or otherwise applied in molten form), forming a strong bond upon setting. This is especially so in the case of a porous substrate 11 (such as Teslin™), since the adhesive permeates a distance into the substrate 11 before setting (not shown in the Figures for clarity).

Any suitable additive such as a pigment which absorbs laser radiation at an appropriate wavelength may be used. In the present example, the additive is a white pigment which undergoes a colour change to black upon irradiation by an IR Nd:YAG laser operating at a wavelength of around 1064 nm. A suitable additive is a calcined powder of co-precipitated tin and antimony as described in WO 02/083567. At the concentrations required to achieve effective laser inscription, the white pigment causes the adhesive layer 12 to become near opaque to the human eye. For example, an additive concentration in the range of around 1 to 10% (based on dry coat weight) has been found suitable for an adhesive layer thickness of around 50 μm to 80 μm. Higher additive levels and thicker adhesive layers yield the best laser marking results, so in this example a preferred configuration has a layer thickness of 75 μm with an additive concentration of between 5 and 10%.

The adhesive layer 12 is then printed, for example by offset, litho, inkjet or xerographic printing to produce one or more print layers P₁. Finally, the coated substrate 11 is sealed on one, or preferably both sides, by a laminate 15 including a cover layer 14 of preferably transparent plastic such as PET. The cover layer 14 has an adhesive layer 13 thereon, which is preferably of the same type as the adhesive 12 applied to the substrate 11 (though the laser markable additive is preferably excluded to avoid affecting the appearance of the print layer P₁). On application to the printed substrate 11, the two adhesive layers 12 and 13 form a strong bond with one another, with the print layer P₁ surrounded on both sides by adhesive.

It should be noted that, instead of printing onto the adhesive layer 12, the printed data P₁ may be applied to the surface of adhesive layer 13, forming part of laminate 15.

Typically, the printed data P₁ comprises graphics, text or symbols which are to be common to all, or at least a number of, the documents so produced. For example, the printed data P₁ may simply be in the form of a background pattern to improve the appearance of the document. The print P₁ could include security features such as fine line designs and could be applied using coloured or security inks, such as UV or IR responsive inks, to increase the difficulty of forgery.

As noted above, adhesive layers 12 and 13 are preferably formed of the same adhesive material although this need not be the case provided the two layers are compatible with one another, forming a strong bond. The adhesive used is preferably a heat sealing adhesive which, when heated, melts or flows, thus forming a strong bond between the two adjacent adhesive layers. Where similar adhesive materials are used for layers 12 and 13, on bonding the layers effectively merge into one another forming a single continuous adhesive layer. Bonding can be achieved using a standard lamination process in which temperatures typically reach around 110 degrees C. After lamination, the layers cannot be separated without destroying the printed data P₁ held within the adhesive 12,13.

The lower side of the substrate may be printed directly on the substrate 11, as shown in FIG. 1, or left unprinted, and if necessary may be sealed in a conventional manner using a laminate 18 comprising a cover layer 17 and adhesive 16. The laminate 18 is typically of the same construction as laminate 15 provided on the upper surface of the article. The print P₂ is generally of a similar nature to print layer P₁ in that it comprises graphics, text or symbols which are not unique to each individual article. Alternatively an adhesive layer may be applied to the lower side of the substrate 11 and the print P₂ is applied on top of the adhesive layer.

In practice, the article structure described may be manufactured in rolls or large sheets rather than as individual articles. Hence, the so-assembled laminate structure may, at this stage, be cut into individual articles of the desired size. The documents can now be transferred from the article manufacturer to a user such as an ID document issuing agency. In cases where the article is a security element rather than a document, the next step may be to attach the element to the product (e.g. document) it is to secure. This may involve applying the element to the product's surface (e.g. bonding the lower side of the element onto the product), or incorporating it into the product (e.g. encapsulating it within a product during manufacture).

The article may then be subjected to laser marking, using for example a Nd:YAG laser operating at around 1064 nm as previously described. In the example of FIG. 1, if the substrate 11 is transparent to the laser radiation, the laser beam may be directed towards the card from either side, since the only laser markable layer is the adhesive layer 12 applied directly to the substrate 11. Laser marking is preferably used to inscribe personalisation data into the article and as such this would typically be carried out by the user (to whom the data is available), rather than the source manufacturer. Since this can be carried out when all other manufacturing steps is complete, each article can be laser marked individually, rather than sheet-by-sheet.

The laser inscription may be visible and/or tactile. For example, the irradiation could cause the adhesive layer 12 to undergo a colour change such as blacking. Alternatively or in addition, the radiation could cause the layer 12 to ‘foam’, whereby microscopic bubbles from within the irradiated area, causing the layer 12 to expand locally. How the layer 12 responds to the irradiation depends on the nature of the adhesive layer 12 and the additive used, as well as the laser inscription conditions (e.g. size of laser marked data, laser power, etc) and the thickness of the cover laminate 15.

By selecting appropriate conditions, some or all of the laser inscribed area can become raised relative to the surface of the article, leading to tactility which increases the security of the article further. FIG. 1a shows a portion of the article of FIG. 1 after laser marking has taken place. Laser marked regions of adhesive layer 12 are designated ‘L’ and it will be seen that selected ones of these have undergone expansion (e.g. by selecting a higher laser power to produce these marks). The expansion results in a relief, R, being detectable through the protective cover 15. The relief R may overlap with the print P₁ if desired.

In one example, tactile text was inscribed using a Nd:YAG laser operating at 1064 nm onto a Teslin™-based ID card with a protective laminate, substantially as described above. The first adhesive layer contains a laser absorbent additive from the Micabs™ range supplied by Royal DSM N.V. Text of around 4 mm and around 2 mm height (i.e. the typical distance from the base to the top of a letter or digit: this is determined by the selected font size) was inscribed using a laser power of 83% and the marked areas on the finished card were found to be raised by approximately 70 μm and 20 μm respectively, relative to the card surface, which was detectable by touch. The extent of tactility can be adjusted by varying factors including beam focus, velocity, frequency, track length and the way that inscribed data is built up.

The final structure has increased security due to the multiple visible data layers (printed data P₁, P₂ and inscribed data), as well as tactile data (if provided) and is tamper evident due to the frangible nature of the print layer P₁ and the irreversible laser inscription. Moreover, the method permits any material to be used for the core substrate, including Teslin™, thus enabling a strong, lightweight, durable document.

FIG. 2 shows an second embodiment of an article 20 in which the upper surface of the substrate 21 is treated in the same manner as in the case of the first embodiment, with print layer P₁ encapsulated between adhesive layers 22 and 23, and protected by cover layer 24. Adhesive layer 22 is laser-markable as described above.

In this embodiment, the lower surface of the substrate 21 is also coated with a laser-markable adhesive layer 29, the print layer P₂ being provided thereon in a manner akin to print layer P₁. The print layer P₂ is covered by a laminate 28, comprising cover layer 27 and adhesive layer 26 such that print layer P₂ is incorporated between the adhesive layers 29 and 26.

The article 20 can therefore display both printed and laser-inscribed data on both sides. In this example, during laser inscription, the laser beam should be applied from the side of the card on which the laser inscription is to be visible.

A third embodiment of the invention is depicted in FIGS. 3 and 4. In this example, the article 30 is a document in the form of an identity card. FIG. 3 shows the upper surface of the card 30, illustrating various items of data which are visible either in daylight and/or under certain illumination conditions (such as UV or IR) if security inks are used. FIG. 4 shows the upper portion of a cross section through the card 30, taken along line A-AA. The lower portion of the card is not shown but could take the form described in either the first or the second embodiment above.

Data items 31, 32 and 33 are printed data, forming part of print layer P₁. Decorative border 31 is printed in colour to enhance the appearance of the card 30. In practice, the whole of the area of the card may be printed with a colour background. Text 32 is common to all cards 30 of this type. Symbol 33 is a security element, printed using a security ink which is not visible in daylight but can be detected under UV illumination. All of the features 31, 32 and 33 are encapsulated within adhesive layers 37 and 38 such that, should an attempt be made to delaminate the card 30, the features will be damaged or destroyed as the adhesive is pulled apart.

Data items 34 and 35a, 35b are provided in the form of laser inscription, caused by modification of the adhesive layer 38 by the response of the additive to laser irradiation. Here, the laser inscription is visible rather than tactile but it could be either or both. Inscribed regions are indicated as L in FIG. 4. The nature of the modification caused by laser irradiation will depend on the additive and adhesive materials selected. Preferably, the additive is absorbent to laser radiation at the applied wavelength(s), which leads to local heating of the adhesive layer 37. This can result in the formation of voids and/or charring (blackening), leading to a visually noticeable mark.

As mentioned above, data inscribed by laser preferably comprises personalisation information and in this example this includes a photograph 34 of the holder of the ID card 30, as well as identification information 35a and a unique code 35b, which may be machine readable.

It will be noted that the printed and inscribed data items may, in some cases, overlap one another whereas in other examples they may be laterally spaced apart. In the example shown in FIGS. 3 and 4, inscribed code 35b overlaps printed symbol 33. However, the inscribed code 35b remains visible since the action of the laser inscription will typically also reduce the visibility of the print layer P₁.

In further examples the article of the current invention can be made machine readable by the introduction of detectable materials in any of the layers previously described (particularly one or more of the adhesive layers) or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

Furthermore the secure article of the current invention could also comprise an antenna and integrated circuit chip. Such an embodiment is depicted schematically in FIG. 5. Preferably the substrate structure 41 would comprise two layers 41a, 41b of Teslin™ (or other suitable material) with the chip 42 (e.g. a RFID chip) and the antenna 43 placed between the two layers of Teslin™ 41a, 41b. In this embodiment the two layers of Teslin™ 41a, 41b are adhered together using a layer 44 of plasticized PVC, however any suitable adhesive could be used. In this embodiment, the upper surface of the top Teslin™ layer 41a is coated with a laser-markable adhesive layer 45, the print layer P₁ being provided thereon in the same manner as described with respect to FIG. 1. The print layer P₁ is then covered by a PET laminate, comprising a cover layer 47 and an adhesive layer 46 such that print layer P₁ is incorporated between the two adhesive layers 45, 46. The lower Teslin™ substrate 41b may be printed directly on the substrate, as described in FIG. 1, or left unprinted, and may be sealed in a conventional manner using a laminate comprising a cover layer 48 and adhesive (not shown).

The secure article of the current invention could also comprise a hologram applied to the first adhesive layer. The embossed transfer of holograms onto identity cards is well known (see for example U.S. Pat. No. 6,954,293). A hologram typically comprises a thermoplastic lacquer into which is embossed a diffractive structure. If the hologram is to be recognizable by reflection, a further metal layer with high reflectivity is provided on or under the embossing layer. U.S. Pat. No. 6,954,293 teaches that a laser can be used to mark the hologram and therefore can provide personalised data. Preferably the laser would be used to remove the metal layer and thereby produce a mark which is easily recognisable.

If such a hologram is attached to the first adhesive layer of the article of the current invention then both the hologram and the laser-markable adhesive can be laser marked at the same time providing two laser marked regions which are in perfect register. In this manner a laser marked image can be written such that it is partly within the hologram and partly in the adhesive region adjacent to the hologram. An embodiment of such an article is shown in the ID card 50 in FIG. 6. A hologram 51 is incorporated into the laminate structure between the laser-markable adhesive layer and the protective cover. The card 50 is marked with a laser producing a laser-inscribed region 52 of the laser-markable adhesive layer in perfect register with a laser-inscribed region 53 of the hologram in which the metallic layer has been ablated. The advantage of a personalised laser inscription is that the counterfeiter would have to match this when producing a counterfeit document and would in effect have to replace both the hologram and the printed data.

1. A method of manufacturing a security article comprising:
applying an first adhesive layer to a substrate, the first adhesive layer comprising an additive which is responsive to at least a selected wavelength of laser radiation; and
applying a laminate over the first adhesive layer, the laminate comprising a second adhesive layer which adheres to the first adhesive layer;
wherein, prior to applying the laminate over the first adhesive layer, data is printed onto the first and/or second adhesive layer, such that on applying the laminate over the first adhesive layer, the printed data is incorporated between the first and second adhesive layers.

2. A method according to claim 1, further comprising:
irradiating a selected region of the security article with laser radiation of at least the selected wavelength, thereby inscribing data into the first adhesive layer.

3. A method according to claim 1, wherein the additive incorporated in the first adhesive layer is absorbent to radiation of at least the selected wavelength.

4. A method according to claim 1, wherein the first adhesive layer undergoes an optically recognisable change upon exposure to radiation of at least the selected wavelength.

5. A method according to claim 1, wherein the first adhesive layer undergoes a physically recognisable change upon exposure to radiation of at least the selected wavelength.

6. A method according to claim 1, wherein the first adhesive layer is blackened upon exposure to radiation of at least the selected wavelength.

7. A method according to claim 1, wherein at least part of the first adhesive layer is substantially opaque in the visible spectrum.

8. A method according to claim 1, wherein the first adhesive layer is applied to the substrate in at least partially molten form.

9. A method according to claim 1, wherein data is printed onto the first or second adhesive layer by offset, lithographic, inkjet or xerographic printing.

10. A method according to claim 1, wherein the first and second adhesive layers comprise the same adhesive material, such that upon bonding to one another, a single continuous adhesive layer is formed, with the printed data incorporated therein.

11. A method according to claim 1, wherein the first and/or second adhesive layers comprise a heat sealing adhesive.

12. A method according to claim 1, wherein the laminate further comprises a protective cover layer of substantially transparent material

13. A method according to claim 12, wherein the cover layer comprises a plastics material.

14. A method according to claim 1, wherein the laminate is applied by roll lamination.

15. A method according to claim 1, wherein the additive comprises a pigment.

16. A method according to claim 1, wherein the selected wavelength of radiation is in the range of around 240 nm to around 11000 nm.

17. A method according to claim 1, wherein the substrate has upper and lower surfaces, the first adhesive layer being applied to the upper surface, further comprising:
applying a second laminate to the lower surface of the substrate.

18. A method according to claim 17, wherein the second laminate comprises a fourth adhesive layer, and, prior to applying the second laminate:
a third adhesive layer is applied to the lower surface of the substrate, the third adhesive layer comprising an additive which is responsive to at least a selected wavelength of laser radiation; and
data is printed onto the third and/or fourth adhesive layer, such that on applying the second laminate over the third adhesive layer, the printed data is incorporated between the third and fourth adhesive layers.

19. A method according to claim 17, wherein the second laminate comprises a protective cover layer.

20. A method according to claim 17, wherein the upper and/or lower surface of the substrate is printed prior to application of the first and/or third adhesive layers.

21. A method according to claim 1 further comprising, after applying the laminate, cutting the assembled substrate and laminate combination into individual articles.

22. A security article comprising:
a substrate having upper and lower surfaces;
a first adhesive layer applied to the upper surface of the substrate, the first adhesive layer comprising an additive which is responsive to at least a selected wavelength of laser radiation;
a print layer; and
a laminate comprising a second adhesive layer bonded to the first adhesive layer, the print layer being incorporated between the first and second adhesive layers.

23. An article according to claim 22, wherein the substrate comprises a porous material.

24. An article according to claim 22, wherein the first and second adhesive layers comprise the same adhesive material such that, when bonded together, the first and second adhesive layers form a single continuous adhesive layer, the print layer being incorporated therewithin.

25. An article according to claim 22, wherein the laminate further comprises a protective cover layer of transparent material.

26. An article according to claim 22, manufactured by the process of:
applying an first adhesive layer to a substrate, the first adhesive layer comprising an additive which is responsive to at least a selected wavelength of laser radiation; and
applying a laminate over the first adhesive layer, the laminate comprising a second adhesive layer which adheres to the first adhesive layer;
wherein, prior to applying the laminate over the first adhesive layer, data is printed onto the first and/or second adhesive layer, such that on applying the laminate over the first adhesive layer, the printed data is incorporated between the first and second adhesive layers.

27. An article according to claim 22 wherein the article is a security document.

28. An article according to claim 22 wherein the article is a security element suitable for application to or incorporation into a product.

29. An article according to claim 28, wherein the security element is an insert, label, transfer, thread or patch.
